(19) United States
(12) Patent Application Publication
(10) Pub. No.: US 2025/0296511 A1
(43) Pub. Date: Sep. 25, 2025

(54) ON-VEHICLE DOUBLE OPENING STORAGE DEVICE

(71) Applicant: TOYODA GOSEI CO., LTD., Kiyosu-shi (JP)

(72) Inventors: Taiki SUMITANI, Kiyosu-shi (JP); Yu HISHIDA, Kiyosu-shi (JP); Naoyuki FUKUI, Kiyosu-shi (JP)

(21) Appl. No.: 19/065,277

(22) Filed: Feb. 27, 2025

(30) Foreign Application Priority Data
Mar. 21, 2024 (JP) 2024-045728

(51) Int. Cl. B60R 7/04; E05B 83/32; E05D 11/10; E05D 15/50

(52) U.S. Cl. CPC B60R 7/04; E05B 83/32; E05D 11/1014; E05D 15/502; E05Y 2900/538

(57) ABSTRACT

An on-vehicle double opening 20 storage device 1 includes:
a case member 2;
a lid member 3;
a hinge member 4 interposed between the case member 2 and the lid member 3, the hinge member 4 including a first shaft 41, a second shaft 42, and a hinge arm 44; and
a switching element 5 that changes a connection state between the lid member 3, the hinge member 4, and the case member 2 to switch an opening/closing mode of the lid member 3 between a closing mode, a first opening mode, and a second opening mode, wherein
the first shaft 41, the second shaft 42, and the hinge arm 44 are integrally resin-molded.

### TECHNICAL FIELD

The present disclosure relates to a double opening storage device mounted on a vehicle.

### BACKGROUND ART

As a storage device mounted on a vehicle, a storage device such as a center console box, in which an opening of a case member is opened and closed by a lid member, has been known.

As this type of storage device, an on-vehicle double opening storage device in which an opening is opened and closed from both sides by a lid member has been proposed (refer to Japanese Laid-Open Patent Publications Nos. 2018-076014, H9-317310, and 2022-153193, for example).

### SUMMARY OF INVENTION

### Technical Problem

The lid member of the aforementioned on-vehicle double opening storage device, in short, rotates around a first axis positioned at one end side of the case member so that the position of the lid member is changed between a first opened position at which the opening of the case member is opened and a closed position at which the opening is closed. At this time, the lid member is considered to open and close the opening from one side. Since this “one side” is also considered to be “the other end side” described below, the lid member at this time is considered to open and close the opening from the other end side, around the first axis positioned at the one end side of the case member.

The lid member rotates around a second axis positioned at the other end side of the case member so that the position of the lid member is changed between a second opened position at which the opening of the case member is opened and a closed position at which the opening is closed. At this time, the lid member is considered to open the opening from the other side. Since this “the other side” is also considered to be the “one end side” described above, the lid member at this time is considered to open and close the opening from the one end side, around the second axis positioned at the other end side of the case member.

The lid member of the on-vehicle double opening storage device opens and closes the opening of the case member from both the one end side and the other end side of the case member, and therefore has an advantage of excellent convenience.

On the other hand, such an on-vehicle double opening storage device requires a mechanism for opening and closing the lid member from the other end side around the first axis, a mechanism for opening and closing the lid member from the one end side around the second axis, and a mechanism for switching the opening/closing direction of the lid member between the one end side and the other end side. Therefore, the number of components of the on-vehicle double opening storage device is significantly larger than the number of components of a general on-vehicle single opening storage device.

Incidentally, it is very difficult to manufacture components of various devices according to designed dimensions. Generally, each component is molded with an error in the shape. A tolerance is set for each component. Even when the dimension of each component is within the range of the tolerance, if the number of components of a device is large, the errors of the components are accumulated.

Therefore, in such a device having a large number of components, the positional relationship between the components in the actual device is sometimes significantly different from that at the time of designing the device. If the dimensional difference becomes excessively large, backlash may occur between the components when the vehicle is traveling or the device is operated, for example.

In the on-vehicle double opening storage device disclosed in Japanese Laid-Open Patent Publication No. 2022-153193, the mechanism for opening and closing the lid member from the other end side around the first axis, the mechanism for opening and closing the lid member from the one end side around the second axis, and the mechanism for switching the opening/closing direction of the lid member between the one end side and the other end side are appropriately unitized and integrated. Thus, in the on-vehicle double opening storage device disclosed in Japanese Laid-Open Patent: Publication No. 2022-153193, the number of components is significantly reduced, compared to the on-vehicle double opening storage devices disclosed in Japanese Laid-Open Patent Publications Nos. 2018-076014 and H9-317310.

However, even in the on-vehicle double opening storage device disclosed in Japanese Laid-Open Patent Publication No. 2022-153193, the number of components is still large, and it is difficult to consider that the problem of backlash, which occurs when the vehicle is traveling or the device is operated, is completely solved.

To date, measures against various noises in vehicles have been taken. In electric vehicles and hybrid vehicles which have remarkably emerged in recent years, quietness in vehicles has been particularly promoted. Therefore, further quietness is required of various devices disposed inside the vehicle, and further quietness is also required of the on-vehicle double opening storage device.

The present invention has been made in view of the above circumstances, and an object of the present invention is to provide an on-vehicle double opening storage device that suppresses backlash when a vehicle is traveling or the device is operated.

### Solution to Problem

In order to solve the above problem, an on-vehicle double opening storage device of the present disclosure includes:
a case member having a box shape with an internal space, and having an opening through which the internal space communicates with the outside;
a lid member the position of which is changeable between a closed position at which the lid member closes the opening of the case member, a first opened position at which the lid member opens the opening by rotating, from the closed position, around a first axis disposed at one end side of the case member, and a second opened position at which the lid member opens the opening by rotating, from the closed position, around a second axis parallel to the first axis and disposed at the other end side of the case member;
a hinge member interposed between the case member and the lid member, the hinge member including a first shaft that is tubular in shape, forms a part of the first axis, and is pivotally supported by the case member, a second shaft that is tubular in shape, forms a part of the second axis, extends in a direction opposite to the first shaft, and is pivotally supported by the lid member, and a hinge arm connecting the first shaft and the second shaft; and
a switching element that changes a connection state between the lid member, the hinge member, and the case member to switch an opening/closing mode of the lid member between a closing mode that locks the lid member at the closed position, a first opening mode that makes the lid member rotatable between the closed position and the first opened position, and a second opening mode that makes the lid member rotatable between the closed position and the second opened position, wherein
the first shaft, the second shaft, and the hinge arm are integrally resin-molded.

According to the on-vehicle double opening storage device of the present disclosure, it is possible to suppress backlash when the vehicle is traveling or the on-vehicle double opening storage device is operated.

### BRIEF DESCRIPTION OF DRAWINGS

FIG. 1 schematically illustrates an on-vehicle double opening storage device according to Embodiment 1 in a disassembled state;

FIG. 2 schematically illustrates a part of a case member, a lid lower part, a hinge member, and a switching element in the on-vehicle double opening storage device of Embodiment 1 as viewed from above;

FIG. 3 illustrates an enlarged view of a main part of FIG. 2;

FIG. 4 schematically illustrates a part of the case member and the hinge member in the on-vehicle double opening storage device according to Embodiment 1;

FIG. 5 schematically illustrates the hinge member in the on-vehicle double opening storage device according to Embodiment 1;

FIG. 6 schematically illustrates a state in which the hinge member is assembled to the case member in the on-vehicle double opening storage device according to Embodiment 1;

FIG. 7 schematically illustrates the switching element in the on-vehicle double opening storage device according to Embodiment 1;

FIG. 8 schematically illustrates a cross-sectional view of the on-vehicle double opening storage device according to Embodiment 1 taken at a position A-A in FIG. 3;

FIG. 9 schematically illustrates a state in which the lid is disposed at a first opened position in the on-vehicle double opening storage device according to Embodiment 1; and

FIG. 10 schematically illustrates a state in which the lid is disposed at a second opened position in the on-vehicle double opening storage device according to Embodiment 1.

### DESCRIPTION OF EMBODIMENT

In the on-vehicle double opening storage device of the present disclosure, similarly to the various on-vehicle double opening storage devices described above, a lid member rotates around a first axis or a second axis to open and close an opening of a case member from both sides.

The on-vehicle double opening storage device of the present disclosure includes a case member, a lid member, a hinge member, and a switching element.

Of these components, the hinge member is a member interposed between the case member and the lid member, and includes a first shaft that forms a part of the first axis and is pivotally supported by the case member, a second shaft that forms a part of the second axis and is pivotally supported by the lid member, and a hinge arm connecting the first shaft and the second shaft.

In a conventional on-vehicle double opening storage device including a hinge member, a first shaft, a second shaft, and a hinge arm are molded as separate members, and are assembled to be integrated with each other. This is because the first shaft and the second shaft are made of metal and the hinge arm is made of resin in the conventional on-vehicle double opening storage device.

That is, the first shaft and the second shaft are preferably made of metal because these parts particularly require dimensional accuracy. However, if the hinge arm is also made of metal in addition to the first shaft and the second shaft, the mass of the on-vehicle double opening storage device becomes excessive, and moreover, moldability of the entire hinge member including the first shaft, the second shaft, and the hinge arm is degraded. Therefore, in the conventional on-vehicle double opening storage device, the first shaft and the second shaft are made of metal and are molded separately from the hinge arm, and these parts are assembled to be integrated with each other.

Also, in the on-vehicle double opening storage device described in Japanese Laid-Open Patent Publication No. 2022-153193, a first shaft, a second shaft, and a hinge arm are molded as separate parts, and are assembled to be integrated with each other.

However, when the first shaft, the second shaft, and the hinge arm, which have been molded as separate parts, are assembled to be integrated with each other, the dimensional errors of the respective members are accumulated, which sometimes causes backlash between the components when the vehicle is traveling or the device is operated.

In the on-vehicle double opening storage device of the present disclosure, the first shaft, the second shaft, and the hinge arm are integrally resin-molded to form the hinge member. Therefore, the number of components of the on-vehicle double opening storage device of the present disclosure is reduced, and the above problem, i.e., accumulation of dimensional errors, does not arise. Thus, according to the on-vehicle double opening storage device of the present disclosure, it is possible to suppress backlash when the vehicle is traveling or the on-vehicle double opening storage device is operated.

The hinge member in which the first shaft, the second shaft, and the hinge arm are integrally resin-molded is advantageous in that the degree of freedom regarding the shape is high and the production cost is reduced, compared to the hinge member in which these components are integrally metal-molded. The on-vehicle double opening storage device of the present disclosure having such a hinge member is also advantageous in that the degree of freedom regarding the shape of the hinge member is high and the production cost is reduced.

In the on-vehicle double opening storage device of the present disclosure, the first shaft and the second shaft each have a tubular shape.

If the first shaft and the second shaft are solid in shape, a shape failure such as a sink mark is likely to occur when these parts are resin-molded. Therefore, it is difficult to produce a solid first shaft and a second shaft with high molding accuracy.

In the on-vehicle double opening storage device of the present disclosure, since the first shaft and the second shaft are tubular in shape (i.e., hollow in shape) to be thinned, occurrence of a molding failure such as a sink mark is suppressed. Therefore, according to the on-vehicle double opening storage device of the present disclosure, even when the hinge member is integrally molded with a resin material, the molding accuracy of the first shaft and the second shaft in the hinge member is improved. This also allows the on-vehicle double opening storage device of the present disclosure to suppress backlash when the vehicle is traveling or the on-vehicle double opening storage device is operated.

Hereinafter, the on-vehicle double opening storage device of the present disclosure is described for each of the components thereof.

Unless otherwise specified, a numerical range “x to y” described in the specification includes a lower limit x and an upper limit y. Such an upper limit value and a lower limit value, and values described in embodiments, may be arbitrarily combined to form a numerical range. Furthermore, any values selected from such a numerical range may be used as an upper limit value and a lower limit value.

The on-vehicle double opening storage device of the present disclosure includes a case member, a lid member, a hinge member, and a switching element.

Of these components, the case member has a box shape having an internal space, and has an opening through which the internal space communicates with the outside. The opening may be formed in any surface of the case member. For example, the opening may face upward, or may face the side of the case member.)

The case member only needs to store various types of items in the internal space, and specific usage, shape, material, etc., of the case member are not particularly limited.

It is particularly preferable that the case member is a molded product made of a resin material. The “resin material” in this specification only needs to contain a resin as a main component. The resin material may contain materials other than resins, such as carbon fibers and glass fibers.

The lid member opens and closes the opening of the case member by being changed in position between a closed position, a first opened position, and a second opened position. Of these positions, at the closed position, the lid member closes the opening of the case member. At each of the first opened position and the second opened position, the lid member fully opens the opening of the case member.

At the first opened position, the lid member is in the state of having been rotated from the closed position around a first axis positioned at one end side of the case member, and opens the opening of the case member.

At the second opened position, the lid member is in the state of having been rotated from the closed position around a second axis positioned at the other end side of the case member, and opens the opening of the case member.

In other words, the lid member opens and closes the opening from the other end side around the first axis positioned at the one end side of the case member, and opens and closes the opening from the one end side around the second axis positioned at the other end side of the case member.

Here, the “first axis” and the “second axis” are virtual axes. In actuality, a first shaft of the hinge member described below forms a part of the first axis, and a second shaft of the hinge member forms a part of the second axis.

The lid member only needs to open and close the opening, and the material and the shape of the lid member are not particularly limited. It is particularly preferable that the lid member is a molded product made of a resin material.

The hinge member is obtained by integrally resin-molding the first shaft, the second shaft, and the hinge arm, and is interposed between the case member and the lid member.

The first shaft of the hinge member is pivotally supported by the case member, and the second shaft is pivotally supported by the lid member. Therefore, the hinge member rotates around the first shaft with respect to the case member. The lid member rotates around the second shaft with respect to the hinge member.

When the lid member and the case member with the opening being closed are relatively fixed to each other, the lid member is locked at the closed position.

At this time, the lid member and the case member only need to be relatively positioned and fixed, and may be directly fixed to each other or indirectly fixed through another member.

When the lid member and the hinge member are fixed to each other and the lid member and the case member are opened with respect to one another, the lid member and the hinge member become integrally rotatable with respect to the case member around the first shaft. This allows the lid member to change the position through rotation between the closed position and the first opened position.

At this time, the lid member and the hinge member only need to be relatively positioned and fixed, and may be directly fixed or indirectly fixed through another member.

When the hinge member and the case member are fixed to each other, the lid member and the hinge member are opened with respect to one another, and the lid member and the case member are opened with respect to one another, the lid member becomes rotatable around the second shaft with respect to the hinge member and the case member. This allows the lid member to change its position through rotation between the closed position and the second opened position.

At this time, the hinge member and the case member only need to be relatively positioned and fixed, and may be directly fixed or indirectly fixed through another member.

When the lid member is at the closed position, the hinge member closes the opening together with the lid member. In other words, when the lid member is at the closed position, the hinge member closes a part of the opening. The position of the hinge member at this time is referred to as “hinge closed position” according to need.

When the lid member rotates from the closed position to the first opened position, the hinge member rotates together with the lid member around the first shaft, i.e., the first axis, to open the opening. The position of the hinge member when the opening is opened as described above is referred to as “hinge opened position” according to need.

Since the hinge member and the lid member are in the opened state with respect to one another when the lid member rotates from the closed position to the second opened position, the position of the hinge member is not changed. Therefore, when the lid member rotates between the closed position and the second opened position, the hinge member is left at the hinge closed position.

The hinge member only needs to be operated as described above. The first shaft and the second shaft of the hinge member only need to have a tubular shape, and may have a bottomed tubular shape or a bottomless tubular shape. The first shaft and the second shaft may have any cross-sectional shape in the radial direction, and may have a circular cylindrical shape or a rectangular cylindrical shape. However, the first shaft and the second shaft preferably have a circular cylindrical shape because the first shaft forms a part of the first axis and the second shaft forms a part of the second axis.

The first shaft only needs to form a part of the first axis that is a virtual axis, and the first axis may be formed by only the first shaft. Likewise, the second shaft only needs to form a part of the second axis that is a virtual axis, and the second axis may be formed by only the second shaft.

The shape of the hinge arm is not particularly limited as long as the first shaft and the second shaft are joined by the hinge arm. However, when the lid member rotates between the closed position and the second opened position, the hinge member is disposed at the hinge closed position and closes a part of the opening. Therefore, the hinge member preferably has a shape that does not become bulky at the hinge closed position. Specifically, the hinge arm preferably has a plate shape, a columnar shape, or the like.

The switching element is for switching an opening/closing mode of the lid member between a closing mode, a first opening mode, and a second opening mode by changing the connection state of the lid member, the hinge member, and the case member.

The switching element, in the closing mode, locks the lid member at the closed position.

Specifically, in the closing mode, the switching element causes the lid member and the case member with the opening being closed to be fixed with each other.

Moreover, the switching element, in the first opening mode, makes the lid member rotatable between the closed position and the first opened position.

Specifically, in the first opening mode, the switching element causes the lid member and the hinge member to be fixed to each other, and causes the lid member and the case member to be opened with respect to one another.

Furthermore, in the second opening mode, the switching element makes the lid member rotatable between the closed position and the second opened position.

Specifically, in the second opening mode, the switching element causes the hinge member and the case member to be fixed to each other, causes the lid member and the hinge member to be opened with respect to one another, and causes the lid member and the case member to be opened with respect to one another.

The switching element only needs to switch the opening/closing mode of the lid member between the closing mode, the first opening mode, and the second opening mode, and the switching mechanism thereof is not particularly limited.)

The switching element may have a first connection element, a second connection element, and a center plate as in Embodiment 1 described below, for example. The first connection element, the second connection element, and the center plate will be described in detail in Embodiment 1.

Furthermore, the on-vehicle double opening storage device of the present disclosure preferably includes a vibration suppression part that is disposed on one of the lid member and the switching element, and comes into pressure contact with the other one of the lid member and the switching element while being elastically deformed. The vibration suppression part is also considered to be interposed between the lid member and the switching element.

The vibration suppression part interposed between the lid member and the switching element suppresses, with its elastic restoring force, relative positional change between the lid member and the switching element in a direction approaching each other. Therefore, the vibration suppression part suppresses vibration of the lid member and the switching element when the vehicle is traveling or the device is operated, and consequently suppresses backlash that occurs between the lid member and the switching element.

The vibration suppression part may be made of an elastic material such as rubber, and may be assembled to and integrated with the lid member or the switching element. However, in terms of cost, it is preferable that the vibration suppression part is resin-molded integrally with the lid member or the switching element.

The on-vehicle double opening storage device of the present disclosure may have a similar vibration suppression part at one of the lid member and the hinge member. In this case, the vibration suppression part comes into pressure contact with the other one of the lid member and the hinge member while being elastically deformed, and suppresses backlash that occurs between the lid member and the hinge member.

Furthermore, the on-vehicle double opening storage device of the present disclosure may have a similar vibration suppression part at one of the case member and the hinge member. In this case, the vibration suppression part comes into pressure contact with the other one of the case member and the hinge member while being elastically deformed, and suppresses backlash that occurs between the case member and the hinge member.

Hereinafter, the on-vehicle double opening storage device of the present disclosure will be described by means of specific examples.

### Embodiment 1

An on-vehicle double opening storage device according to Embodiment 1 is a center console box disposed between a driver seat and a front passenger seat in a compartment of a vehicle.

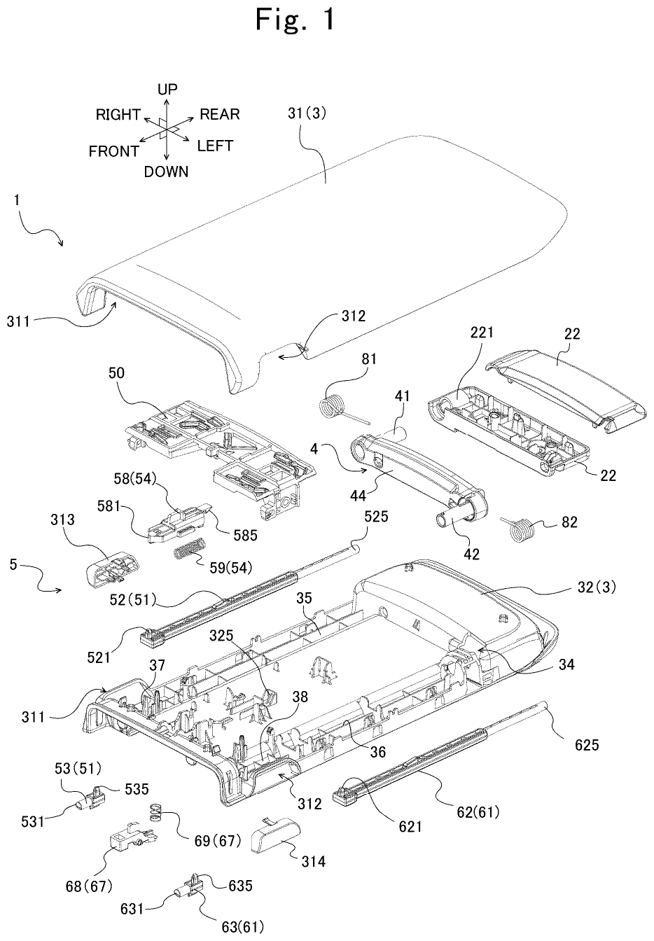

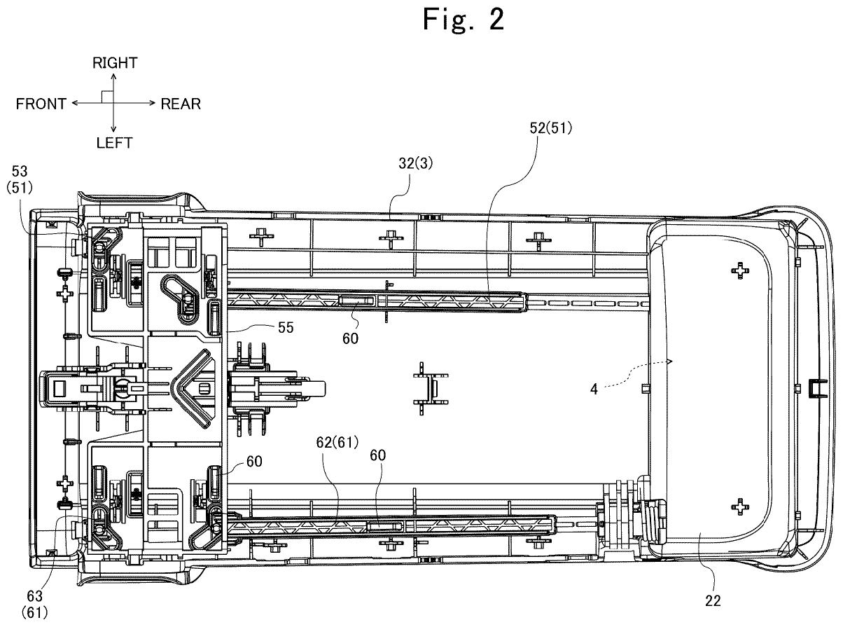

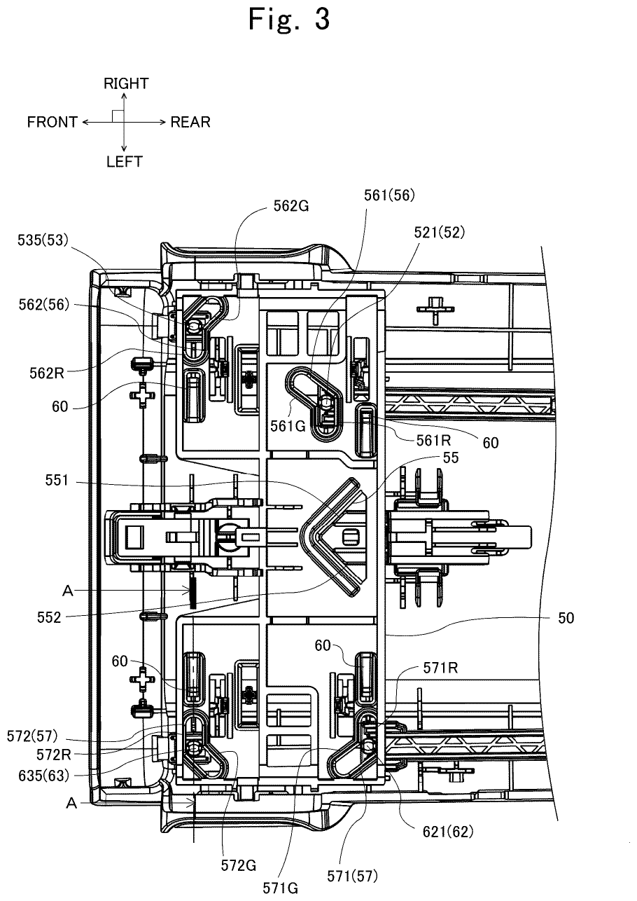

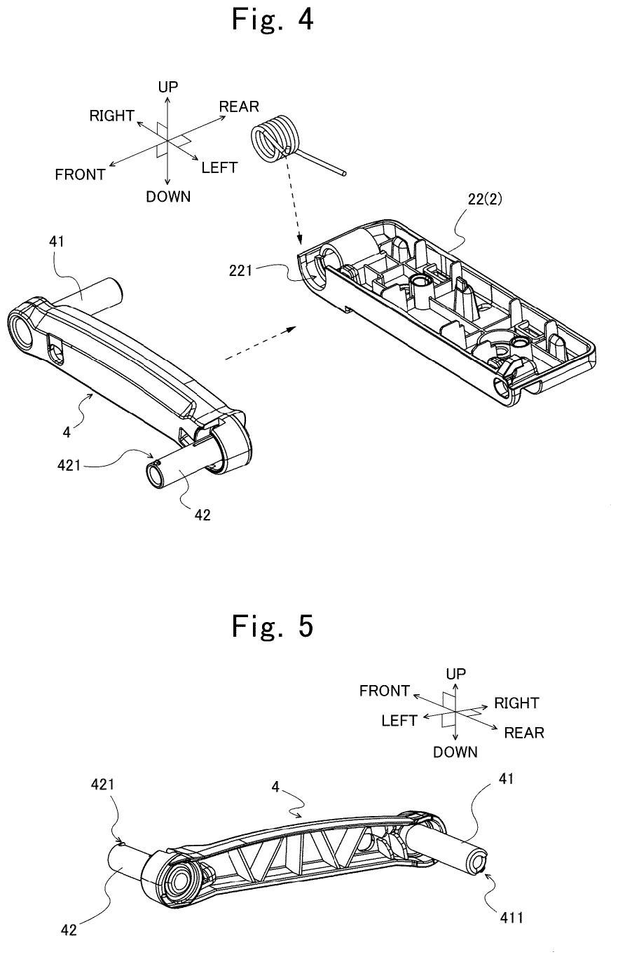

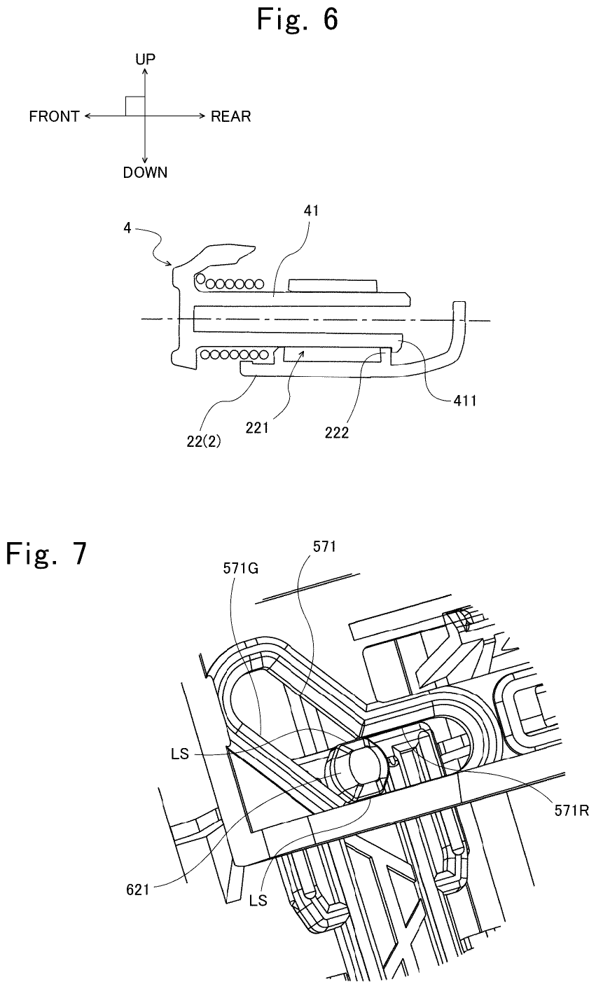

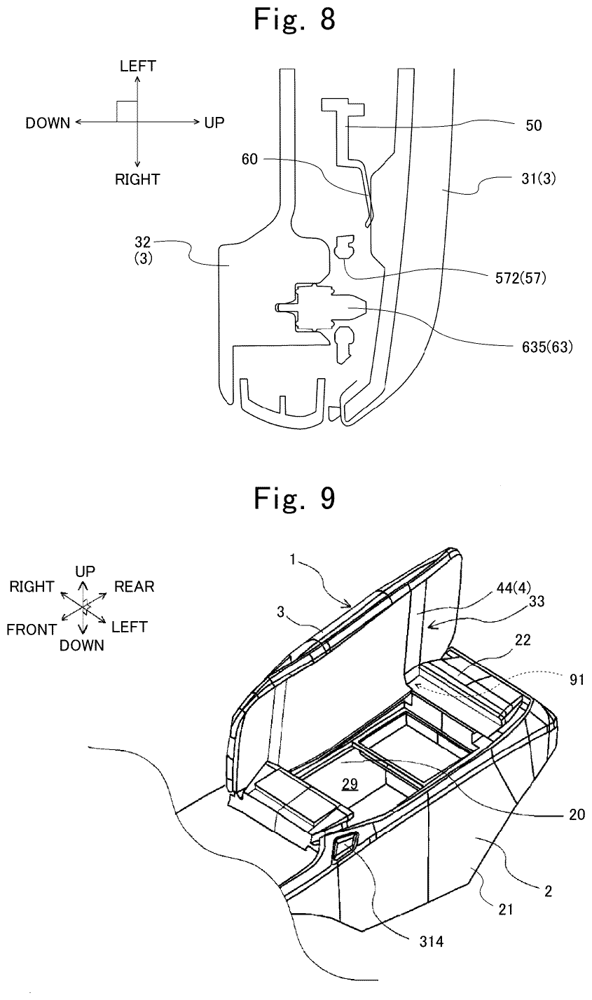

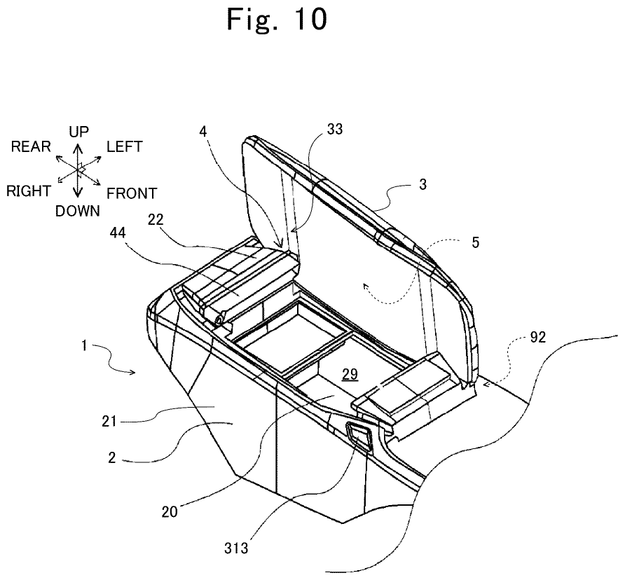

FIG. 1 schematically illustrates an on-vehicle double opening storage device according to Embodiment 1 in a disassembled state. FIG. 2 schematically illustrates a part of a case member, a lid lower part, a hinge member, and a switching element in the on-vehicle double opening storage device of Embodiment 1 as viewed from above. FIG. 3 shows an enlarged view of a main part of FIG. 2. FIG. 4 schematically illustrates a part of the case member and the hinge member in the on-vehicle double opening storage device according to Embodiment 1. FIG. 5 schematically illustrates the hinge member in the on-vehicle double opening storage device according to Embodiment 1. FIG. 6 schematically illustrates a state in which the hinge member is assembled to the case member in the on-vehicle double opening storage device according to Embodiment 1. FIG. 7 schematically illustrates the switching element in the on-vehicle double opening storage device according to Embodiment 1. FIG. 8 schematically illustrates a cross- sectional view of the on-vehicle double opening storage device according to Embodiment 1 taken at a position A-A in FIG. 3. FIG. 9 schematically illustrates a state in which the lid member is disposed at a first opened position in the on-vehicle double opening storage device according to Embodiment 1. FIG. 10 schematically illustrates a state in which the lid member is disposed at a second opened position in the on-vehicle double opening storage device according to Embodiment 1.

Hereinafter, “up”, “down”, “left”, “right”, “front”, and “rear” respectively refer to “up”, “down”, “left”, “right”, “front”, and “rear” in each figure.

As shown in FIG. 1, an on-vehicle double opening storage device 1 of Embodiment 1 includes a case member 2, a lid member 3, a hinge member 4, a switching element 5, a first opening urging element 81, and a second opening urging element 82.

As shown in FIG. 9 and FIG. 10, the lid member 3 in the on-vehicle double opening storage device 1 of Embodiment 1 rotates around a first axis 91 (virtual axis) positioned at one end side of the case member 2, whereby the position of the lid member 3 is changed between a first opened position (FIG. 9) at which an opening 20 of the case member 2 is opened, and a closed position at which the opening 20 is closed. Furthermore, the lid member 3 rotates around a second axis 92 (virtual axis) positioned at the other end side of the case member 2, whereby the position of the lid member 3 is changed between a second opened position (FIG. 10) at which the opening 20 of the case member 2 is opened, and a closed position at which the opening 20 is closed.

That is, the lid member 3 in the on-vehicle double opening storage device 1 of Embodiment 1 opens and closes the opening 20 of the case member 2 from both the left side as the other end side and the right side as the one end side.

The first axis 91 and the second axis 92 are parallel to each other, and correspond to the front-rear direction. The width direction orthogonal to the axis direction (also referred to as “orthogonal-to-axis direction”) corresponds to the left-right direction.

As shown in FIG. 9 and FIG. 10, the case member 2 has a box shape that has an internal space 29 and is opened upward. The internal space 29 serves as a storage space for storing items. The internal space 29 communicates with the outside through the opening 20.

The case member 2 includes a box-shaped case main body 21, and a case end part 22 mounted to a rear portion of the case main body 21.

As shown in FIG. 1, the lid member 3 has a substantially box shape obtained by assembling and integrating a lid upper part 31 and a lid lower part 32. The lid upper part 31 has a shallow box shape and opens downward, and the lid lower part 32 has a substantially plate shape and covers the opening of the lid upper part 31 from the lower side.

As shown in FIG. 9 and FIG. 10, a hinge housing portion 33 extending in the left-right direction is disposed in a rear portion of the lid lower part 32 in the lid member 3. The hinge housing portion 33 has a recessed shape that is recessed upward and opened downward. A second pivotal support part 34 having a through-hole shape extending in the front-rear direction is disposed in the rear and left-end portion of the lid lower part 32. The hinge housing portion 33 is capable of housing a hinge arm 44 of the hinge member 4 described later, and a second shaft 42 of the hinge member 4 described later is inserted in the second pivotal support part 34 from the rear side.

A second hinge-side slide groove 36 extending in the front-rear direction is disposed in the left end portion, of the lid lower part 32, on the front side relative to the hinge housing portion 33. In addition, a first hinge-side slide groove 35 extending in the front-rear direction is disposed in the right end portion, of the lid lower part 32, on the front side relative to the hinge housing portion 33.

Furthermore, a first case-side slide groove 37 extending in the front-rear direction is disposed in a position on the front and slightly right side relative to the first hinge-side slide groove 35. A second case-side slide groove 38 extending in the front-rear direction coaxially with the first hinge-side slide groove 35 is disposed at a position on the front side relative to the second hinge-side slide groove 36.

A structure for supporting a center plate 50, positioning pin bodies, etc., described below, is disposed at a position between the first hinge-side slide groove 35 and the second hinge-side slide groove 36 in the lid lower part 32. This structure will be described later in detail.

A first operation window 311 that extends in the left-right direction and opens rightward is formed in a front and right side end portion of each of the lid upper part 31 and the lid lower part 32. A second operation window 312 that extends in the left-right direction and opens leftward is formed in a front and left side end portion of each of the lid upper part 31 and the lid lower part 32.

A first opening operation button 313 is inserted in the first operation window 311, and a second opening operation button 314 is inserted in the second operation window 312. A far-side end portion of the first opening operation button 313 faces the center plate 50 from the right side, and a far-side end portion of the second opening operation button 314 faces the center plate 50 from the left side.

The hinge member 4 includes a first shaft 41 extending in the front-rear direction and having a substantially cylindrical shape, a second shaft 42 extending in the front-rear direction and having a substantially cylindrical shape, and a hinge arm 44 extending in the left-right direction and having a columnar shape. The first shaft 41, the second shaft 42, and the hinge arm 44 are integrally resin-molded.

A right end portion of the hinge arm 44 is integrated with a front end portion of the first shaft 41, and a left end portion of the hinge arm 44 is integrated with a rear end portion of the second shaft 42. Therefore, it is considered that the first shaft 41 extends rearward from the right end portion of the hinge arm 44, and the second shaft 42 extends frontward from the left end portion of the hinge arm 44.

As shown in FIG. 4, a first pivotal support portion 221 having a through-hole shape and extending in the front-rear direction is formed at a right end portion of the case end part 22. A rear end portion of the first shaft 41 is inserted in the first pivotal support part 221 from the front side. This allows the hinge member 4 to rotate around the first shaft 41 with respect to the case member 2.

As shown in FIG. 5, a hook-shaped first shaft-side engagement part 411 is formed at the rear end portion of the first shaft 41. As shown in FIG. 6, a first case-side engagement part 222 with which the first shaft-side engagement part 411 is engaged is disposed at the far side, i.e., rear side, of the first pivotal support part 221. The first shaft-side engagement part 411 and the first case-side engagement part 222 are engaged with each other in the front-rear direction within a rotation region of the first shaft 41 when the lid member 3 rotates between the closed position and the first opened position, thereby restricting a positional change of the first shaft 41 in the front-rear direction.

Engagement of the first shaft-side engagement part 411 and the first case-side engagement part 222 is released outside the rotation region of the first shaft 41. Therefore, with the first shaft-side engagement part 411 being rotated to an angle outside the rotation region, the hinge member 4 having the first shaft 41 is mounted to the case member 2 having the case end part 22, and the hinge member 4 is dismounted from the case member 2.

As shown in FIG. 4, a hook-shaped second shaft engagement part 421 is formed at a front end portion of the second shaft 42. The front end portion of the second shaft 42 is inserted in the second pivotal support part 34 of the lid member 3 from the rear side. This allows the lid member 3 to rotate around the second shaft 42 with respect to the hinge member 4.

A second lid engagement part (not shown) with which the second shaft engagement part 421 is engaged is disposed at the far side, i.e., the front side, of the second pivotal support part 34. The second shaft engagement part 421 and the second lid engagement part are engaged with each other in the front-rear direction within a rotation region of the second shaft 42 when the lid member 3 rotates between the closed position and the second opened position, thereby restricting a positional change of the second shaft 42 in the front-rear direction.

Engagement of the second shaft engagement part 421 and the second lid engagement part is released outside the rotation region of the second shaft 42. Therefore, with the second shaft engagement part 421 being rotated to an angle outside the rotation region, the hinge member 4 having the second shaft 42 is mounted to the lid member 3 having the lid lower part 32, and the hinge member 4 is dismounted from the lid member 3.

In the on-vehicle double opening storage device 1 of Embodiment 1, the first opening urging element 81 is mounted between the first shaft 41 and the case member 2. The first opening urging element 81 is a torsion coil spring. The torsion coil spring is in an urging force accumulated state when the lid member 3 is at the closed position, urges the hinge member 4 from the hinge closed position to the hinge opened position, and consequently urges the lid member 3 from the closed position to the first opened position shown in FIG. 9.

Furthermore, in the on-vehicle double opening storage device 1 of Embodiment 1, the second opening urging element 82 is mounted between the second shaft 42 and the lid member 3. The second opening urging element 82 is a torsion coil spring. The torsion coil spring is in an urging force accumulated state when the lid member 3 is at the closed position, and urges the lid member 3 from the closed position to the second opened position shown in FIG. 10 when the hinge member 4 is at the hinge closed position.

As shown in FIG. 1 to FIG. 3, the switching element 5 includes a first connection element 51, a second connection element 61, a center plate 50, a width-direction restriction element 54, a height-direction restriction element 67, a first opening operation button 313, and a second opening operation button 314.

The first connection element 51 includes a first hinge connector 52 and a first case connector 53.

Of these connectors, the first hinge connector 52 has a long rod shape extending in the front-rear direction, is disposed in the first hinge-side slide groove 35, and is mounted to the lid member 3. The position of the first hinge connector 52 is changeable in the front-rear direction within the first hinge-side slide groove 35.

A rear end portion of the first hinge connector 52 forms a first hinge engagement part 525 protruding rearward. A first hinge engagement guide pin 521 protruding upward is disposed at a front end portion of the first hinge connector 52.

The first case connector 53 has a short rod shape extending in the front-rear direction, is disposed in the first case-side slide groove 37, and is mounted to the lid member 3. The position of the first case connector 53 is changeable in the front-rear direction within the first case-side slide groove 37.

A front end portion of the first case connector 53 forms a first case engagement part 531 protruding frontward. A first case engagement guide pin 535 protruding upward is disposed at a rear end portion of the first case connector 53.

The second connection element 61 includes a second hinge connector 62 and a second case connector 63.

Of these connectors, the second hinge connector 62 has a long rod shape extending in the front-rear direction, is disposed in the second hinge-side slide groove 36, and is mounted to the lid member 3. The position of the second hinge connector 62 is changeable in the front-rear direction within the second hinge-side slide groove 36.

A rear end portion of the second hinge connector 62 forms a second hinge engagement part 625 protruding rearward. A second hinge engagement guide pin 621 protruding upward is disposed at a front end portion of the second hinge connector 62.

The second case connector 63 has a short rod shape extending in the front-rear direction, is disposed in the second case-side slide groove 38, and is mounted to the lid member 3. The position of the second case connector 63 is changeable in the front-rear direction within the second case-side slide groove 38.

A front end portion of the second case connector 63 forms a second case engagement part 631 protruding frontward. A second case engagement guide pin 635 protruding upward is disposed at a rear end portion of the second case connector 63.

The center plate 50 is a member having a substantially plate shape, and is mounted to the lid lower part 32. The position of the center plate 50 is changeable in a direction intersecting the lid member 3 in the axial direction, more specifically, in the left-right direction.

A far-side end portion of the first opening operation button 313 is engaged with a right end of the center plate 50, and a far-side end portion of the second opening operation button 314 is engaged with a left end of the center plate 50. Thus, the center plate 50, the first opening operation button 313, and the second opening operation button 314 are integrated with each other. A right side portion of the first opening operation button 313 is exposed to the inside of the first operation window 311 through the opening formed at a front side right end portion of each of the lid lower part 32 and the lid upper part 31. A left side portion of the second opening operation button 314 is exposed to the inside of the second operation window 312 through the opening formed at a front side left end portion of each of the lid lower part 32 and the lid upper part 31.

The center plate 50 is provided with a first engagement guide groove 56, a second engagement guide groove 57, and a centering guide groove 55 which penetrate the center plate 50 in the up-down direction. Of these grooves, the first engagement guide groove 56 is composed of a first hinge engagement guide groove 561 and a first case engagement guide groove 562. The second engagement guide groove 57 is composed of a second hinge engagement guide groove 571 and a second case engagement guide groove 572.

The first hinge engagement guide groove 561 is disposed at a right-rear side position in the center plate 50. The first case engagement guide groove 562 is disposed at a right-front side position in the center plate 50. The second hinge engagement guide groove 571 is disposed at a left-rear side position in the center plate 50. The second case engagement guide groove 572 is disposed at a left-front side position in the center plate 50.

The first hinge engagement guide groove 561 includes a relief part 561R linearly extending in the left-right direction, and a guide part 561G that is continuous with a right end portion of the relief part 561R and further linearly extends rightward and frontward. A groove wall of the first hinge engagement guide groove 561 linearly extends in the left-right direction in the relief part 561R, and linearly extends from the left-rear side to the right-front side in the guide part 561G.

The first hinge engagement guide pin 521 of the first hinge connector 52 is inserted in the first hinge engagement guide groove 561.

The first case engagement guide groove 562 includes a relief part 562R linearly extending in the left-right direction, and a guide part 562G that is continuous with a right end portion of the relief part 562R and further linearly extends rightward and rearward. A groove wall of the first case engagement guide groove 562 linearly extends in the left-right direction in the relief part 562R, and linearly extends from the left-front side to the right-rear side in the guide part 562G.

The first case engagement guide pin 535 of the first case connector 53 is inserted in the first case engagement guide groove 562.

The second hinge engagement guide groove 571 includes a relief part 571R linearly extending in the left-right direction, and a guide part 571G that is continuous with a left end portion of the relief part 571R and further linearly extends leftward and frontward. A groove wall of the second hinge engagement guide groove 571 linearly extends in the left-right direction in the relief part 571R, and linearly extends from the right-rear side to the left-front side in the guide part 571G.

The second hinge engagement guide pin 621 of the second hinge connector 62 is inserted in the second hinge engagement guide groove 571.

The second case engagement guide groove 572 includes a relief part 572R linearly extending in the left-right direction, and a guide part 572G that is continuous with a left end portion of the relief part 572R and further linearly extends leftward and rearward. A groove wall of the second case engagement guide groove 572 linearly extends in the left-right direction in the relief part 572R, and linearly extends from the right-front side to the left-rear side in the guide part 572G.

The second case engagement guide pin 635 of the second case connector 63 is inserted in the second case engagement guide groove 572.

The centering guide groove 55 is disposed at a front-side center position in the center plate 50. The centering guide groove 55 has an isosceles triangle shape with an apex facing frontward and a base facing rearward.

A groove wall of the centering guide groove 55 includes a first centering wall part 551 extending from the rear and right side to the front and center side, and a second centering wall part 552 extending from the rear and left side to the front and center side.

The width-direction restriction element 54 includes a width restriction body 58 and a width urging element 59, and is mounted to the lid lower part 32.

Of these components, the width restriction body 58 has a short columnar shape, and is supported such that the position thereof is changeable in the front-rear direction with respect to the lid lower part 32. The width restriction body 58 has a tapered centering projection part 581 at one end thereof, and a hook- shaped stopper 585 at the other end. The stopper 585 is engaged with a stopper engagement part 325 disposed on the lid lower part 32, and restricts a rearward positional change of the width restriction body 58 that exceeds a predetermined range in the front-rear direction. The centering projection part 581 is inserted in the centering guide groove 55 of the center plate 50.

The width urging element 59 is a helical spring, and is mounted in a compressed state between the width restriction body 58 and the lid lower part 32.

The width urging element 59 urges the width restriction body 58 forward, whereby the centering projection part 581 is pressed against the groove wall of the centering guide groove 55, i.e., the first centering wall part 551 or the second centering wall part 552.

The height-direction restriction element 67 includes a height restriction body 68 and a height urging element 69, and is mounted to the lid lower part 32.

Of these components, the height restriction body 68 has a short columnar shape, and is pivotally supported so as to be tiltable with respect to the lid lower part 32. One end portion of the height restriction body 68 faces a lower surface of the center plate 50 from below, and the other end portion of the width restriction body 58 faces an upper surface of the lid lower part 32 from above.

The height urging element 69 is a helical spring, and is mounted in a compressed state between the one end portion of the height restriction body 68 and the center plate 50. The height-direction restriction element 67 urges the center plate 50 upward, thereby restricting the position of the center plate 50 in the up-down direction.

As shown in FIG. 7, the second hinge engagement guide pin 621 of the second hinge connector 62 has a sliding contact surface that comes into slidable contact with the groove wall of the second hinge engagement guide groove 571. A portion of the sliding contact surface extends parallel to the direction in which the groove wall of the second hinge engagement guide groove 571 extends, and comes into linear contact or planar contact with the groove wall of the second hinge engagement guide groove 571.

Specifically, the portion of the sliding contact surface is a pair of long surfaces LS extending parallel to a pair of groove walls of the relief part 571R in the second hinge engagement guide groove 571, and the long surfaces LS come into slidable contact with the groove walls of the relief part 571R.

Likewise, the first hinge engagement guide pin 521 of the first hinge connector 52 has a sliding contact surface that comes into slidable contact with the groove wall of the first hinge engagement guide groove 561. A portion of the sliding contact surface extends parallel to the direction in which the groove wall of the first hinge engagement guide groove 561 extends, and comes into linear contact or planar contact with the groove wall of the first hinge engagement guide groove 561.

Specifically, the portion of the sliding contact surface is long surfaces extending parallel to a pair of groove walls of the relief part 561R in the first hinge engagement guide groove 561, and comes into slidable contact with the groove walls of the relief part 561R.

Likewise, the first case engagement guide pin 535 of the first case connector 53 has a sliding contact surface that comes into slidable contact with the groove wall of the first case engagement guide groove 562. A portion of the sliding contact surface extends parallel to the direction in which the groove wall of the first case engagement guide groove 562 extends, and comes into linear contact or planar contact with the groove wall of the first case engagement guide groove 562.

Specifically the portion of the sliding contact surface is long surfaces extending parallel to a pair of groove walls of the relief part 562R in the first case engagement guide groove 562, and comes into slidable contact with the groove walls of the relief part 562R.

Likewise, the second case engagement guide pin 635 of the second case connector 63 has a sliding contact surface that comes into slidable contact with the groove wall of the second case engagement guide groove 572. The portion of the sliding contact surface extends parallel to the direction in which the groove wall of the second case engagement guide groove 572 extends, and comes into linear contact or planar contact with the groove wall of the second case engagement guide groove 572.

Specifically, the portion of the sliding contact surface is long surfaces extending parallel to a pair of groove walls of the relief part 572R in the second case engagement guide groove 572, and comes into slidable contact with the groove walls of the relief part 572R.

The switching element 5 includes a plurality of vibration suppression parts 60. As shown in FIG. 8, each vibration suppression part 60 is, for example, disposed on the center plate 50, and comes into pressure contact with the lid member 3 while being elastically deformed. Thus, the vibration suppression part 60 restricts relative positional change in the direction in which the lid member 3 and the switching element 5 approach each other. Thus, vibrations of the lid member 3 and the switching element 5 are suppressed when the vehicle is traveling or the device is operated, thereby suppressing backlash that occurs between the lid member 3 and the switching element 5.

Hereinafter, the operation of the on-vehicle double opening storage device 1 of Embodiment 1 will be described.

The switching element 5 switches the opening/closing mode of the lid member 3 between the closing mode, the first opening mode shown in FIG. 9, and the second opening mode shown in FIG. 10.

### Closing Mode

In the closing mode, the switching element 5 locks the lid member 3 at the closed position. At this time, the lid member 3 is disposed at the lid closed position, and the hinge member 4 is disposed at the hinge closed position.

In the closing mode, the center plate 50 is centered in the width direction and the height direction by the width-direction restriction element 54 (i.e., the width restriction body 58 and the width urging element 59) and the height-direction restriction element 67 (i.e., the height restriction body 68 and the height urging element 69), respectively, and is disposed at the center position shown in FIG. 3.

When the center plate 50 is disposed at the center position shown in FIG. 3, the first hinge engagement part 525 of the first hinge connector 52 enters an engagement hole of the hinge arm 44 located rearward of the center plate 50, whereby the first hinge connector 52 and the hinge member 4 are engaged with each other.

In addition, at this time, the first case engagement part 531 of the first case connector 53 enters an engagement hole of the case main body 21 located frontward of the center plate 50, whereby the first case connector 53 and the case member 2 are engaged with each other.

In addition, at this time, the second hinge engagement part 625 of the second hinge connector 62 enters the second shaft 42 located rearward of the center plate 50, passes through the second shaft 42, and enters the engagement hole located rearward of the second shaft 42 of the case end part 22. Thus, the second hinge connector 62, the hinge member 4, and the case member 2 are engaged with each other.

Furthermore, at this time, the second case engagement part 631 of the second case connector 63 enters the engagement hole of the case main body 21 located frontward of the center plate 50, whereby the second case connector 63 and the case member 2 are engaged with each other.

In other words, at this time, the lid member 3, the hinge member 4, and the case member 2 are connected to each other at both the left end side and the right end side of the case member 2 through the first connection element 51 and the second connection element 61, and are locked with each other. The lid member 3, the hinge member 4, and the case member 2 being connected as described above allow the lid member 3 to be locked at the closed position.

### First Opening Mode

In the first opening mode, the switching element 5 makes the lid member 3 rotatable between the closed position and the first opened position.

If the user performs an operation of pressing the second opening operation button 314 when the on-vehicle double opening storage device 1 of Embodiment 1 is in the closing mode, the center plate 50 is pressed by the second opening operation button 314, and the position of the center plate 50 is changed rightward.

When the center plate 50 has slid rightward from the center position shown in FIG. 3 by a predetermined length, the position of the center plate 50 is relatively changed rightward with respect to the second hinge connector 62, and the second hinge engagement guide pin 621 enters the guide part 571G of the second hinge engagement guide groove 571.

The guide part 571G of the second hinge engagement guide groove 571 linearly extends leftward and frontward. Therefore, at this time, the second hinge engagement guide pin 621 comes into contact with the groove wall of the second hinge engagement guide groove 571, and is guided by the second hinge engagement guide groove 571 so that the position thereof is changed frontward. The second hinge connector 62 having the second hinge engagement guide pin 621 also slides frontward.

When the second hinge connector 62 has slid frontward, the position of the second hinge engagement part 625 of the second hinge connector 62 is changed frontward in the second shaft 42, whereby engagement of the second hinge connector 62 and the case member 2 is released. At this time, the second hinge engagement part 625 of the second hinge connector 62 remains inside the second shaft 42. Therefore, at this time, engagement of the second hinge connector 62 and the hinge member 4 is maintained.

Furthermore, at this time, the second case engagement guide pin 635 enters the guide part 572G of the second case engagement guide groove 572. Since the guide part 572G of the second case engagement guide groove 572 linearly extends leftward and rearward, the second case engagement guide pin 635 is guided by the second case engagement guide groove 572 so that the position thereof is changed rearward, and the second case connector 63 having the second case engagement guide pin 635 also slides rearward.

When the second case connector 63 has slid rearward, the second case engagement part 631 of the second case connector 63 is disengaged rearward from the engagement hole of the case member 2, whereby engagement of the second case connector 63 and the case member 2 is released.

Meanwhile, at this time, the first hinge engagement guide pin 521 enters the relief part 561R of the first hinge engagement guide groove 561. Since the relief part 561R linearly extends in the left-right direction, the position of the first hinge engagement guide pin 521 is not changed at this time. Therefore, at this time, engagement of the first hinge connector 52 and the hinge member 4 is maintained.

Furthermore, at this time, the first case engagement guide pin 535 enters the relief part 562R of the first case engagement guide groove 562. Since the relief part 562R linearly extends in the left-right direction, the position of the first case engagement guide pin 535 is not changed at this time. Therefore, at this time, engagement of the first case connector 53 and the case member 2 is maintained.

At this time, engagement of the second hinge connector 62 and the case member 2 by the switching element 5 is released, engagement of the second case connector 63 and the case member 2 is released, and engagement of the second hinge connector 62 and the hinge member 4 is maintained. Engagement of the first hinge connector 52 and the hinge member 4 by the switching element 5 is maintained, and engagement of the first case connector 53 and the case member 2 is maintained.

Therefore, at this time, the lid member 3 and the hinge member 4 are integrally rotatable with respect to the case member 2 around the first axis 91.

In this state, if the user cancels the operation of pressing the second opening operation button 314, the lid member 3 rotates around the first axis 91 with respect to the case member 2 due to an urging force of the first opening urging element 81, and the position of the lid member 3 is changed to the first opened position shown in FIG. 9. At this time, the lid member 3 is merely urged to the first opened position by the urging force of the first opening urging element 81, and is not locked. Therefore, at this time, the lid member 3 is rotatable between the first opened position and the closed position.

Moreover, at this time, the operation of pressing the second opening operation button 314 by the user is canceled. Therefore, the center plate 50 is centered in the width direction and the height direction by the width-direction restriction element 54 and the height-direction restriction element 67, respectively, and is returned to the center position shown in FIG. 3.

### Second Opening Mode

In the second opening mode, the switching element 5 makes the lid member 3 rotatable between the closed position and the second opened position.

If the user performs an operation of pressing the first opening operation button 313 when the on-vehicle double opening storage device 1 of Embodiment 1 is in the closing mode, the center plate 50 is pressed by the first opening operation button 313, and the position of the center plate 50 is shifted leftward.

When the center plate 50 has slid leftward from the center position shown in FIG. 3 by a predetermined length, the position of the center plate 50 is relatively changed leftward with respect to the first hinge connector 52, and the first hinge engagement guide pin 521 enters the guide part 561G of the first hinge engagement guide groove 561.

The guide part 561G of the first hinge engagement guide groove 561 linearly extends rightward and frontward. Therefore, at this time, the first hinge engagement guide pin 521 comes into contact with the groove wall of the first hinge engagement guide groove 561, and is guided by the first hinge engagement guide groove 561 so that the position thereof is changed frontward. The first hinge connector 52 having the first hinge engagement guide pin 521 also slides frontward.

When the first hinge connector 52 has slid frontward, the first hinge engagement part 525 of the first hinge connector 52 is disengaged frontward from the engagement hole of the hinge arm 44, whereby engagement of the first hinge connector 52 and the hinge member 4 is released.

Furthermore, at this time, the first case engagement guide pin 535 enters the guide part 562G of the first case engagement guide groove 562. Since the guide part 562G of the first case engagement guide groove 562 linearly extends rightward and rearward, the first case engagement guide pin 535 is guided by the first case engagement guide groove 562 so that the position thereof is changed rearward, and the first case connector 53 having the first case engagement guide pin 535 also slides rearward.

When the first case connector 53 has slid rearward, the first case engagement part 531 of the first case connector 53 is disengaged rearward from the engagement hole of the case member 2, whereby engagement of the first case connector 53 and the case member 2 is released.

Meanwhile, at this time, the second hinge engagement guide pin 621 enters the relief part 571R of the second hinge engagement guide groove 571. Since the relief part 571R linearly extends in the left-right direction, the position of the second hinge engagement guide pin 621 is not changed at this time. Therefore, at this time, engagement of the second hinge connector 62 and the hinge member 4 is maintained.

Furthermore, at this time, the second case engagement guide pin 635 enters the relief part 572R of the second case engagement guide groove 572. Since the relief part 572R linearly extends in the left-right direction, the position of the second case engagement guide pin 635 is not changed at this time. Therefore, at this time, engagement of the second case connector 63 and the case member 2 is maintained.

At this time, engagement of the first hinge connector 52 and the hinge member 4 by the switching element 5 is released, and engagement of the first case connector 53 and the case member 2 is released. Meanwhile, engagement of the second hinge connector 62, the hinge member 4, and the case member 2 by the switching element 5 is maintained, and engagement of the second case connector 63 and the case member 2 is maintained.

Therefore, at this time, the lid member 3 is rotatable around the second axis 92 including the second shaft 42, the second hinge connector 62, and the second case connector 63, with respect to the case member 2 and the hinge member 4.

At this time, engagement of the second hinge connector 62 and the hinge member 4 by the switching element 5 is maintained, and engagement of the second case connector 63 and the case member 2 is maintained. Therefore, at this time, the hinge member 4 is connected to the case member 2 at both the right end side and the left end side by the first shaft 41, the second shaft 42, the second hinge connector 62, and the second case connector 63, and is not rotatable. In other words, at this time, the hinge member 4 is disposed at the hinge closed position, and remains locked with respect to the case member 2.

In this state, if the user cancels the operation of pressing the first opening operation button 313, the lid member 3 rotates around the second axis 92 with respect to the case member 2 due to the urging force of the second opening urging element 82, and the position of the lid member 3 is changed to the second opened position shown in FIG. 10. At this time, the lid member 3 is merely urged to the second opened position by the urging force of the second opening urging element 82, and is not locked. Therefore, the lid member 3 at this time is rotatable between the second opened position and the closed position.

Furthermore, since the operation of pressing the first opening operation button 313 by the user is canceled at this time, the center plate 50 is centered in the width direction and the height direction by the width-direction restriction element 54 and the height-direction restriction element 67, and is returned to the center position shown in FIG. 3.

In the on-vehicle double opening storage device 1 of Embodiment 1, the first shaft 41 and the second shaft 42 are tubular in shape, and the first shaft 41, the second shaft 42, and the hinge arm 44 are integrally resin-molded. Thus, according to the on-vehicle double opening storage device 1 of Embodiment 1, backlash is suppressed when the vehicle is traveling or the on-vehicle double opening storage device 1 is operated.

Furthermore, in the on-vehicle double opening storage device 1 of Embodiment 1, the sliding contact surface, of the first hinge engagement guide pin 521 of the first hinge connector 52, which is in contact with the groove wall of the first hinge engagement guide groove 561 that guides the guide pin 521, has the long surface LS extending parallel to the groove wall. More specifically, the first hinge engagement guide pin 521 has the long surface LS extending parallel to the groove wall of the relief part 561R in the first hinge engagement guide groove 561.

Likewise, the sliding contact surface, of the first case engagement guide pin 535 of the first case connector 53, which is in contact with the groove wall of the first case engagement guide groove 562 that guides the guide pin 535, has the long surface extending parallel to the groove wall. More specifically, the first case engagement guide pin 535 has the long surface extending parallel to the groove wall of the relief part 562R of the first case engagement guide groove 562.

The sliding contact surface, of the second case engagement guide pin 635 of the second case connector 63, which is in contact with the groove wall of the second case engagement guide groove 572 that guides the guide pin 635, has the long surface extending parallel to the groove wall. More specifically, the second case engagement guide pin 635 has the long surface extending parallel to the groove wall of the relief part 572R of the second case engagement guide groove 572.

Furthermore, the sliding contact surface, of the second case engagement guide pin 635 of the second case connector 63, which is in contact with the groove wall of the second case engagement guide groove 572 that guides the guide pin 635, has the long surface extending parallel to the groove wall. More specifically, the second case engagement guide pin 635 has the long surface extending parallel to the groove wall of the relief part 572R of the second case engagement guide groove 572.

In the on-vehicle double opening storage device 1 of Embodiment 1, as described above, each of the first hinge engagement guide pin 521 of the first hinge connector 52, the first case engagement guide pin 535 of the first case connector 53, the second hinge engagement guide pin 621 of the second hinge connector 62, and the second case engagement guide pin 635 of the second case connector 63, has the long surface LS parallel to the groove wall of the corresponding guide groove (the first hinge engagement guide groove 561, the first case engagement guide groove 562, the second hinge engagement guide groove 571, or the second case engagement guide groove 572), at the sliding contact surface with the groove wall. Therefore, in the on-vehicle double opening storage device 1 of Embodiment 1, the first hinge connector 52, the first case connector 53, the second hinge connector 62, and the second case connector 63 are stably operated without backlash, thereby suppressing backlash and operating noise when the switching element 5 switches the opening/closing mode of the lid member 3 between the closing mode, the first opening mode, and the second opening mode.

The on-vehicle double opening storage device 1 according to the present disclosure is not limited to the above configuration. For example, each of the pins of the hinge connectors and the case connectors may have a long surface extending parallel to the groove wall of the guide part of the corresponding guide groove. Alternatively, each of the pins of the hinge connectors and the case connectors may have both the long surface extending parallel to the groove wall of the relief part of the corresponding guide groove and the long surface extending parallel to the groove wall of the guide part of the guide groove.

either case, like the on-vehicle double opening storage device 1 of Embodiment 1, backlash and operating noise are suppressed when the switching element 5 switches the opening/closing mode of the lid member 3 between the closing mode, the first opening mode, and the second opening mode.

Moreover, in the on-vehicle double opening storage device 1 of Embodiment 1, the switching element 5 includes the vibration suppression part 60. This also allows the on-vehicle double opening storage device 1 of Embodiment 1 to suppress backlash when the vehicle is traveling or the device is operated.

Moreover, in the on-vehicle double opening storage device 1 of Embodiment 1, since the hinge member 4 is resin-molded and the first shaft 41 and the second shaft 42 are tubular in shape, components having fine shapes such as the hook-shaped first shaft-side engagement part 411 and second shaft engagement part 421 are easily formed in the first shaft 41 and the second shaft 42 with high molding accuracy. This achieves further reduction in the number of components of the hinge member 4 in the on-vehicle double opening storage device 1 of Embodiment 1. Therefore, in the on-vehicle double opening storage device 1 of Embodiment 1, the problem regarding accumulation of dimensional errors of many components is solved, thereby further suppressing backlash when the vehicle is traveling or the on-vehicle double opening storage device is operated.

While the present invention has been described above, the present invention is not limited to the embodiments and the like described above. Elements described in the embodiments and the like may be selected and combined as appropriate to implement the present invention, and various modifications may be made without deviating from the scope of the present invention.

The specification of the present invention discloses not only technical features based on the reference relationship of the claims at the time of filing of the present application but also technical features obtained by combining matters described in the claims as appropriate.

1. An on-vehicle double opening storage device, comprising:
a case member having a box shape with an internal space, and having an opening through which the internal space communicates with the outside;
a lid member the position of which is changeable between a closed position at which the lid member closes the opening of the case member, a first opened position at which the lid member opens the opening by rotating, from the closed position, around a first axis disposed at one end side of the case member, and a second opened position at which the lid member opens the opening by rotating, from the closed position, around a second axis parallel to the first axis and disposed at the other end side of the case member;
a hinge member interposed between the case member and the lid member, the hinge member including a first shaft that is tubular in shape, forms a part of the first axis, and is pivotally supported by the case member, a second shaft that is tubular in shape, forms a part of the second axis, extends in a direction opposite to the first shaft, and is pivotally supported by the lid member, and a hinge arm connecting the first shaft and the second shaft; and
a switching element that changes a connection state between the lid member, the hinge member, and the case member to switch an opening/closing mode of the lid member between a closing mode that locks the lid member at the closed position, a first opening mode that makes the lid member rotatable between the closed position and the first opened position, and a second opening mode that makes the lid member rotatable between the closed position and the second opened position, wherein
the first shaft, the second shaft, and the hinge arm are integrally resin-molded.

2. The on-vehicle double opening storage device according to claim 1, further comprising:
a first connection element mounted to the lid member, and including
a first case engagement guide pin, the position of the first case engagement guide pin being changeable in axial directions of the first axis and the second axis,
a first case engagement part that is detachably engaged with the case member by being changed in position integrally with the first case engagement guide pin,
a first hinge engagement guide pin the position of which is changeable in the axial direction, and
a first hinge engagement part that is detachably engaged with the hinge member by being changed in position integrally with the first hinge engagement guide pin;
a second connection element mounted to the lid member and forming a part of the second axis, including
a second case engagement guide pin the position of which is changeable in the axial direction,
a second case engagement part that is detachably engaged with the case member by being changed in position integrally with the second case engagement guide pin,
a second hinge engagement guide pin the position of which is changeable in the axial direction, and
a second hinge engagement part that is detachably engaged with the hinge member by being changed in position integrally with the second hinge engagement guide pin; and
a center plate that is mounted to the lid member so as to be changeable in position in a direction intersecting the axial direction, wherein
the center plate includes
a first engagement guide groove that linearly guides the first case engagement guide pin and the first hinge engagement guide pin being inserted in the groove, in the direction intersecting the axial direction, and
a second engagement guide groove that linearly guides the second case engagement guide pin and the second hinge engagement guide pin being inserted in the groove, in the direction intersecting the axial direction,
the first case engagement guide pin and the first hinge engagement guide pin each have a long surface that comes into linear contact or planar contact with a groove wall of the first engagement guide groove, and
the second case engagement guide pin and the second hinge engagement guide pin each have a long surface that comes into linear contact or planar contact with a groove wall of the second engagement guide groove.

3. The on-vehicle double opening storage device according to claim 1, further comprising a vibration suppression part that is disposed on one of the lid member and the switching element, and comes into pressure contact with the other one of the lid member and the switching element while being elastically deformed.
